(19) United States
(12) Patent Application Publication
(10) Pub. No.: US 2022/0135467 A1
(43) Pub. Date: May 5, 2022

(54) GLASS OR GLASS CERAMIC ELEMENT COMPRISING GLASS OR GLASS CERAMIC SUBSTRATE AND COATING, AND METHOD FOR PRODUCING SAME AND USE THEREOF

(71) Applicant: SCHOTT AG, Mainz (DE)

(72) Inventors: Yvonne Menke-Berg, Wiesbaden (DE); Vera Steigenberger, Bischofsheim (DE); Matthew Moose, Sweetwater, TN (US)

(73) Assignee: SCHOTT AG, Mainz (DE)

(21) Appl. No.: 17/520,235

(22) Filed: Nov. 5, 2021

(30) Foreign Application Priority Data
Nov. 5, 2020 (DE) 10 2020 129 161.2

(51) Int. Cl. C03C 8/20; C03C 8/04; C03C 4/00; C03C 3/078; C03C 3/089; C03C 17/04; C03C 17/00

(52) U.S. Cl. CPC C03C 8/20; C03C 2218/32; C03C 4/00; C03C 3/078; C03C 3/089; C03C 17/04; C03C 17/007; C03C 2204/00; C03C 2207/00; C03C 2217/452; C03C 2217/485; C03C 2217/475; C03C 2217/477; C03C 2217/476; C03C 2218/119; C03C 8/04

(57) ABSTRACT

A glass or glass ceramic element for household and/or heating appliances is provided. The element includes a transparent glass or glass ceramic substrate and a coating. The substrate has a main surface. The coating is on at least a portion of the main surface. The coating is a glass-based coating that includes a pigment and a filler. The pigment includes an IR-reflecting material and the filler has a specific molar heat capacity of not more than 5 mJ/(mol·K).

### CROSS REFERENCE TO RELATED APPLICATIONS

This application claims benefit under 35 USC § 119 of German Application 10 2020 129 161.2 filed Nov. 5, 20201, the entire contents of which are incorporated herein by reference.

### BACKGROUND

### 1. Field of the Invention

The present invention relates to a glass or glass ceramic element suitable for use at elevated temperatures, which comprises a glass or glass ceramic substrate and a coating disposed on at least some area or in some section on at least one of the main surfaces of the glass or glass ceramic element. The present invention furthermore relates to a method for producing such a glass or glass ceramic element and to its use.

### 2. Description of Related Art

Glass or glass ceramic elements are often used in applications in which elevated temperatures may occur during operation. It is known, for example, to use glass or glass ceramic elements as cooking surface cover panels (often simply referred to as “cooking surfaces”), or for viewing windows, for example in fireplaces or in ovens.

In this case, elevated temperatures may arise on the glass element such as a viewing window, and in fact even on the side of the glass element facing away from a heat source. However, this is unfavorable since this side of the glass element is the side facing an operator of an appliance or a user of a heating device such as a fireplace, and which might therefore be touched by the latter. If the surface temperature of this side facing the operator is high, this might therefore entail a risk of injuries such as burns.

Depending on the specific application, it may also be disadvantageous if the heat generated in an appliance escapes to the outside through a viewing window or a cover panel. This is because the viewing window is effective as a heat sink in this case. In the case of fireplaces, for example, this can reduce the efficiency of the combustion process and lead to elevated formation of soot. If the glass element is used as a viewing window in an oven, for example in an oven door, it will also be advantageous if the oven door does not act as a heat sink, but rather the generated heat is kept within the oven muffle. The cooking process of the food in the oven muffle can in fact be enhanced in this way.

In order to keep the outer surface of an oven door as cool as possible, it is common to use a plurality of panes, often three or four panes. The innermost pane is often provided with metallic strips or the like, for example, in order to avoid burns and/or to meet safety requirements.

In order to achieve the most homogeneous mechanical properties possible for a pane, approaches exist to employ two layers, for example. French application FR 3052769 A1, for example, describes a pane on which two layers were applied, namely a Transparent Conductive Oxide (TCO) layer and an enamel-based decorative coating. However, a drawback thereof is that TCO layers are rather sensitive to scratches and therefore the handling of such panes is hampered. Furthermore, the pigments of the decorative coating are large enough, with a particle size between 500 nm and 10 μm, to allow heat radiation to be efficiently scattered on the particles. However, due to the rather large size of the pigment particles, they are difficult to process, and respective wide-meshed screens have to be used for printing such layers, for example in a screen printing process, thereby limiting the resolution of the decoration that is possible therewith.

U.S. Pat. No. 5,898,180 describes the use of non-absorbing IR-reflecting pigments for coating an oven muffle.

Furthermore, international patent application WO 2019/101873 A1 describes a decorative coating with increased IR reflectivity. The coating comprises a glass matrix and IR-reflecting pigments with a Total Solar Reflectance (TSR) value of at least 20%, determined in compliance with ASTM G 173. At a wavelength of 1500 nm, the coating exhibits remission of at least 35%, measured in compliance with ISO 13468.

However, it has been found that the reduction of the surface temperature of a surface of a glass element as achieved with the prior art coatings is still not sufficient.

Furthermore, so-called Thermal Barrier Coatings (TBC) are known, for example for protecting machine components such as turbines which are used at very high temperatures of more than 1000° C., for example. These are usually complex coating systems which comprise at least one ceramic material. The ceramic material is usually applied by a plasma spray process so that a porous coating is obtained as part of the TBC coating system. The grain size of the ceramic material is usually between 5 μm and 120 μm. A selective section-wise application of the coating comprising the ceramic material is not possible by plasma spraying. Also, there is the risk of causing massive damage to the surface of a glass substrate by a plasma spraying process in which the particles of the coating material are catapulted onto the surface of the substrate, which would result in a strong reduction in strength.

Thermal barrier coatings are therefore not suitable for the coating of glass or glass ceramic elements.

Hence, there is a need for improved glass or glass ceramic elements.

### SUMMARY

The object of the invention is to provide glass or glass ceramic elements which are suitable as viewing windows and/or cover plates at elevated temperature and which exhibit a reduced surface temperature on the side facing away from the heat source.

The present disclosure therefore relates to a glass or glass ceramic element for household and/or heating appliances, which comprises a transparent glass or glass ceramic substrate and a coating disposed on at least one main surface of the glass or glass ceramic substrate at least in some area thereof, wherein the coating is a glass-based coating, preferably an enamel coating, and comprises at least one pigment and at least one filler; wherein the at least one pigment preferably comprises an IR-reflecting material; and wherein the at least one filler comprises a material having a specific molar heat capacity of not more than 5 mJ/(mol·K) and preferably a thermal conductivity of not more than 12 W/(m·K).

### BRIEF DESCRIPTION OF THE DRAWINGS

The invention will now be explained in more detail with reference to the figures in which the same reference symbols refer to the same or equivalent elements and wherein:

FIGS. 1 to 3 are schematic side views of glass or glass ceramic elements, not drawn to scale;

FIG. 4 shows a schematic sectional view of a coating, not drawn to scale;

FIG. 5 shows a schematic plan view of a glass or glass ceramic element, not drawn to scale;

FIGS. 6 and 7 are schematic views of measurement setups;

FIG. 8 is a schematic view of a pane assembly for an oven door; and

FIG. 9 shows a temperature graph of an oven door as a function of time.

### DETAILED DESCRIPTION

Specific molar heat capacity is the specific heat capacity related to the molar mass. Thermal diffusivity is the thermal conductivity related to density and specific heat capacity. Corresponding properties of materials are listed in the following table.

TABLE 1

| | | Specific | | Specific | | |
|---|---|---|---|---|---|---|
| | Thermal | heat | Molar | molar heat | | Thermal |
| | conductivity | capacity | mass | capacity | Density | diffusivity |
| | [W/(m · K)] | [J/(g · K)] | [g/mol] | [mJ/(mol · K)] | [kg/m³] | [mm²/s] |
| TiO₂ | 3-4 | 0.70 | 79.87 | 8.76 | 4230 | 1.18 |
| Y₂O₃ | 8-12 | 0.45 | 225.81 | 1.99 | 5010 | 1.55 |
| ZrO₂ | 1.5-3 | 0.45 | 123.22 | 3.65 | 5680 | 1.37 |
| La₂Zr₂O₇ | 2 | 0.35 | 572.26 | 0.61 | 6050 | 1.65 |
| Gd₂Zr₂O₇ | 1.8 | 0.42 | 608.94 | 0.69 | 6950 | 1.20 |
| Nd₂Zr₂O₇ | 1.25 | 0.4 | 582.925 | 0.69 | 6410 | 1.37 |
| La₂Hf₂O₇ | 1.93 | 0.3 | 572.25194 | 0.52 | 7940 | 1.47 |
| 8YSZ | 2.09 | 0.55 | 131.42896 | 4.18 | 6000 | 1.06 |

Such an embodiment has a number of advantages.

The glass or glass ceramic element comprises a transparent glass or glass ceramic substrate and a coating which is disposed on at least one main surface of the glass or glass ceramic substrate in at least one area thereof. The coating is designed so as to comprise at least one pigment and at least one filler, and comes in the form of a glass-based coating, in particular an enamel coating.

The glass or glass ceramic substrate is transparent, that is, it exhibits a transmittance of at least 40% in the wavelength range from 380 nm to 780 nm. It may in particular be preferred for the glass or glass ceramic substrate to be not only transparent, but also uncolored, and here a transparent uncolored embodiment of the glass or glass ceramic substrate is understood to mean that this substrate preferably has a neutral color location within the range of visible light and furthermore exhibits only low absorption. This can be particularly advantageous if the glass or glass ceramic element is intended to be employed as a viewing window in a household and/or heating appliance, such as an oven or a fireplace. This is because in this case, the glass or glass ceramic element will exhibit a corresponding transmittance in the areas not covered by the coating or in the area not covered by the coating, so that a good view through the element is ensured.

The coating comprising a pigment (or similarly a filler) is understood to mean that the coating comprises a pigment, that is a color-imparting body. Pigments, like fillers, are known to be materials which usually come in the form of a powder. Therefore, within the scope of the present disclosure, the expression “comprising a pigment/a filler” is understood to mean comprising or including “a pigment comprising pigment particles/a filler comprising filler particles”.

In other words, the coating according to the present disclosure is implemented as a pigmented coating or, more generally, as a coating that comprises particles.

Such an implementation of the coating as a coating that comprises particles, in particular also as a pigmented coating, can in particular be advantageous when it comes to achieving a certain covering effect, for example if, for safety reasons, only certain areas of a glass element such as a cover panel or a viewing window are allowed to remain free, for example in order to identify certain functional areas as such, or for mechanically protecting particularly stressed areas of a glass element, in particular in a peripheral area.

The at least one pigment preferably comprises an IR-reflecting material. Such an implementation is particularly useful when the surface temperature of a viewing window or of a cover panel shall be kept as low as possible on the user facing side of the window pane or of an appliance or device in or on which the glass element is installed or attached. Such a configuration is also known from Applicant's own application WO 2019/101873 A1, for example. In the context of the present disclosure, IR-reflecting pigment is understood to mean in particular a pigment which has a TSR value of at least 20% as measured in compliance with the ASTM G173 standard. In this way, a coating can be obtained which, at a wavelength of 1500 nm, exhibits a remission of at least 35%, measured in compliance with the ISO 134 68 measurement standard. However, surprisingly, it has been found that if the pigment comes in the form of an absorption pigment, it is already sufficient for achieving a low surface temperature of for instance a pane or window glass, if the coating comprises fillers like those that will be described in more detail further below. In other words, it is not mandatory for the pigment to be in the form of an IR-reflecting pigment.

In the context of the present disclosure, pigment refers to a so-called color body, that is a substance or material which is added to another material such as a coating matrix or a binder and imparts a color and/or a specific effect to that material. In contrast to dyes, pigments do not or at least not completely dissolve in the material to which they are added, but rather remain in the form of a solid or of solid particles, at least partially, preferably even entirely.

It is furthermore known and advantageous to add fillers to a coating. For example, fillers are used to positively affect the behavior of a coating agent such as a paste, for example through steric hindrance to coagulation, or in order to adjust a suitable rheology of the coating agent. It is also possible to advantageously increase scratch resistance of a coating by adding a respective filler to the coating.

In the context of the present disclosure, fillers are generally characterized by the fact that they are not dissolved or will not dissolve in the glass matrix, but rather will be present as a solid, preferably crystalline material comprising particles. The melting temperature is usually well above the melting temperature of so-called frit glasses, i.e. glasses that are used as a glass flux or glass frit in a glass-based coating in the form of an enamel coating, for example, so that the fillers will remain crystalline when the decorations are fired.

In contrast to pigments, the filler is preferably a filler that has little or no effect on the color, in particular it is not a color-imparting pigment.

In the present case, the filler is designed so as to comprise a material having a specific molar heat capacity of not more than 5 mJ/(mol·K) and preferably a thermal conductivity of not more than 12 W/(m·K). In other words, the filler is designed so as to comprise a material that has specific material properties with regard to storage and/or conduction of thermal energy. Simplified, these material properties, that is specific molar heat capacity and thermal conductivity, are also referred to as thermal properties of a material in the context of the present disclosure.

Such an embodiment is not known from the prior art.

Usual fillers in particular include relatively inexpensive materials, since they are used, for example, as a substitute for the usually significantly more expensive pigments, or they include materials which exhibit high scratch resistance, for example, such as fillers made of or comprising Al₂O₃. It is also known to use SiO₂-based fillers which may be employed to adjust the rheology in a coating agent such as a paste, for example. However, it has not been known yet to select fillers based on their properties for storing and/or conducting thermal energy.

Surprisingly, it has been found that with a material that exhibits a specific molar heat capacity of not more than 5 mJ/(mol·K), preferably not more than 2 mJ/(mol·K), and most preferably not more than 1 mJ/(mol·K) or even less as a constituent of a coating for a glass or glass ceramic element, it is possible to even further reduce the surface temperature of a glass or glass ceramic element such as a viewing window or a cover panel. Such a reduction in the surface temperature can in particular be achieved on the side facing away from the heat source. This side of the glass or glass ceramic element is often the side which is not provided with the coating comprising the filler.

The filler is preferably designed so as to include or comprise a material having a thermal conductivity of not more than 12 W/(m·K), preferably not more than 3 W/(m·K), and most preferably not more than 2 W/(m·K). It can be particularly preferred for the material of the filler to have both a low thermal conductivity and a low specific molar heat capacity, i.e. a thermal conductivity of at most 12 W/(m·K) and a specific molar heat capacity of at most 5 mJ/(mol·K).

It has been found that such a material allows to particularly efficiently reduce the surface temperature of one side of a glass or glass ceramic element. This can be particularly advantageous in order to keep the filler content in the coating as low as possible. In fact, it has been found that by adding the filler with special thermal properties, the surface temperature can actually be positively influenced, i.e. lowered, but when added to a pigmented coating, it may offset the color coordinates and/or reduce the opacity of the coating. Also, the surface texture of a coating provided with such a filler might change, in particular it may become rougher. However, such a rough surface texture and/or a shift in the color coordinates and/or a reduction of the covering effect of the coating would be disadvantageous. That is because the color coordinate and/or the opacity of the pigmented coating are, for example, necessary for safety reasons, for example in order to be able to reliably identify functional or hazardous areas of an appliance or a device as such. A change in the surface texture may mean, for example, that the coating is no longer sufficiently scratch-resistant. It may also be the case, for example, that the bondability of the coating is adversely affected in this way. For these reasons, it can therefore be advantageous to use, as a constituent of the filler, a material that is particularly efficient in terms of reducing the surface temperature of one side of the glass element, in order to advantageously keep the content of the filler as low as possible.

In the context of the present disclosure, the following definitions shall apply:

Glass or glass ceramic substrate is understood to mean a shaped body made of or comprising a glass or a glass ceramic.

Glass or glass ceramic element is understood to mean a finished glass or glass ceramic element. Finishing is understood to mean that the substrate has been further processed, in particular coated.

Main surface of a glass or glass ceramic substrate is understood to mean a surface which accounts for at least 40% of the surface area of the shaped body made of or comprising glass or glass ceramic. In the case of a sheet-like shape of the glass or glass ceramic substrate, the main surfaces are often also referred to as sides or faces, for example as the upper or lower side or front or rear side, depending on the exact spatial orientation of the glass or glass ceramic substrate.

Sheet-like shape of a shaped body is understood to mean a shaped body which has a lateral dimension in a first spatial direction of a Cartesian coordinate system which is at least one order of magnitude smaller than in the other two spatial directions perpendicular to this first spatial direction. This first spatial direction may also be considered as the thickness of the shaped body. In other words, a sheet-like shaped body is understood to mean a body which has a thickness that is at least one order of magnitude smaller than the length and width thereof. Length and width may substantially be similar, i.e. of the same order of magnitude. Such a shaped body is also referred to as a sheet. However, it is also possible that the length of the sheet-like shaped body is multiple times greater than the width thereof. In this case one may speak of a ribbon.

Since, as stated above, the glass or glass ceramic element is a finished glass or glass ceramic substrate, the statements for the length and width as well as for the main surfaces or sides of the substrate similarly apply to the element.

At least in the areas of the glass or glass ceramic element in which the coating or possibly also a further coating or even a plurality of coatings are disposed on at least one side (or: main surface), the thickness of the glass or glass ceramic element is resulting as the sum of the substrate thickness and the thickness of the coating or optionally coatings. However, since the thickness of the coating or coatings is usually at least one order of magnitude smaller than the thickness of the substrate, it is possible when specifying the thickness of the element, to approximately assume it to be the thickness of the substrate, and the thickness of the coating or coatings can be neglected.

A glass or glass ceramic substrate is referred to as transparent, here, if it exhibits a light transmittance of at least 40% in the visible wavelength range of the electromagnetic spectrum (i.e. from 380 nm to 780 nm).

Household appliance refers to a device that can be used in the household, in particular in a private household. Household appliances are often referred to as so-called “white goods”. In the context of the present disclosure, household appliances are not only understood to mean appliances for private households or private use, but also appliances such as baking ovens that can also be used in the industrial or commercial sector, i.e. also ovens for industrial or commercial use, for example.

Heater or heating appliance generally refers to a device for generating heat, in particular for heating rooms, inter alia. Heater is in particular understood to mean an oven, for example a fireplace oven.

As far as it is stated within the scope of the present disclosure that a product or a material comprises another material, this is in particular understood to mean that the respective product or material is made predominantly, i.e. more than 50 wt % thereof, or substantially, i.e. more than 90 wt % thereof, or apart from inevitable impurities even entirely of this other material.

Equivalent diameter of a particle is understood to mean the volume-equivalent sphere diameter. As far as a particle size is specified within the context of the present disclosure, this specification refers to the d₅₀ value of the particle distribution based on the equivalent diameter, unless expressly stated otherwise.

In the context of the present disclosure, coating refers to a material layer which differs at least in part from the composition of the substrate on which it is disposed. A coating is in particular also understood to mean a surface area which encompasses a superficial diffusion of the coating into areas of the substrate close to the surface. The coating can thus also encompass diffusion layers at the boundary between the coating and the substrate. Furthermore, what is known as a melting reaction zone may also have formed at the coating-to-substrate interface. The coating according to the present disclosure is in particular obtained by a coating process, that is by applying a coating material, for example a paste, onto a support, in this case the substrate. The coating process may in particular include a liquid coating process such as dip-coating, flood-coating, spin-coating, or doctor blading. Most preferably, the coating process comprises a printing process such as screen printing.

The coating according to the present disclosure includes a solids content. Solids content is understood to mean the fraction of solid constituents in the coating. In the case of a coating that comprises particles, such as a pigmented coating, which is usually produced by applying a liquid coating agent such as a paste onto a substrate and by subsequent thermal treatment that can also be referred to as firing, the solids content is defined by the solid constituents of the coating agent, namely the one or more pigment(s) and the one or more filler(s) and optionally the one or more binder(s). Liquid or volatile constituents of a coating agent such as a “paint” or “printing ink” or a paste therefore do not account for the solids content. In particular solvents or solvent mixtures such as screen printing media or screen printing oils do not account for the solids content of the coating.

It has been found that the surface temperature can be reduced on one side of a glass or glass ceramic element by adding, to a pigmented coating, a filler that comprises zirconium oxide and/or hafnium oxide and/or an oxide of a rare-earth element.

According to a further aspect of the present disclosure, the latter therefore also relates to a glass or glass ceramic element for household and/or heating appliances, which comprises a transparent glass or glass ceramic substrate and a coating disposed on at least one main surface of the glass or glass ceramic substrate at least in an area thereof, wherein the coating is a glass-based coating, preferably an enamel coating, and comprises at least one pigment and at least one filler, wherein the filler is or comprises zirconium oxide and/or hafnium oxide and/or a chalcogenide, in particular an oxide of a rare-earth element.

In the context of the present disclosure, chalcogenide refers to compounds of elements from main group VI (acc. to Mendeleev's scheme) of the periodic table of elements, i.e. the 16^{th} group (of IUPAC groups) of the periodic table of elements, the chalcogenides in particular comprising oxides, sulfides, and selenides, and mixtures thereof.

In the context of the present disclosure, rare-earth elements are considered to include the chemical elements of the 3rd subgroup of the periodic table of elements and the lanthanides.

Such a design of the glass or glass ceramic element with a pigmented coating or, more generally, a coating comprising particles allows in particular to achieve an advantageous reduction in the surface temperature on one side of the glass or glass ceramic element.

The filler may be provided in the form of a mixture, for example, or as a compound of the oxides mentioned above. In fact, it has been found that precisely these oxides have advantageous thermal properties which lead to the desired reduction in the surface temperature of the element in hot applications, that is, for example, as a cover panel or viewing window.

According to one embodiment, the filler is in a form so as to comprise a mixed oxide comprising an oxide of at least one rare-earth element and zirconium oxide and/or hafnium oxide. For example, the filler may comprise La₂Zr₂O₇ or may be in the form of La₂Zr₂O₇. The filler may furthermore comprise Nd₂Zr₂O₇ and/or (Nd,Fe)₂Zr₂O₇ or may be in the form of Nd₂Zr₂O₇ or (Nd,Fe)₂Zr₂O₇.

More generally, without being limited to the specific examples of fillers described above, the filler may be made of or may comprise ZrO₂. The filler may in particular be or comprise cubically stabilized ZrO₂. For example, the filler may be or comprise cubic stabilized ZrO₂ comprising HfO₂.

Alternatively or additionally, the filler may be or may comprise a chalcogenide, in particular an oxide, according to the following formula:

A_{2+X}B_{Y}D_{Z}E₇,

wherein A is at least one element from the group of rare-earth elements and is present as a trivalent cation, B is at least one element which is present as a tetravalent cation, D is at least one element which is present as a pentavalent cation, and E is at least one element which is present as a divalent anion, and wherein:

0≤X≤1.1;

0≤Y≤3;

0≤Z≤1.6;

and wherein furthermore the following applies:

8≤3X+4Y+5Z≤15.

Preferably, the filler is in the form of a crystalline material.

Preferably, the following applies:
0≤X≤1.0, more preferably 0≤X≤0.5, even more preferably 0≤X≤0.25, and most preferably 0≤X≤0.1.

A is preferably selected from the group comprising or consisting of Y, La, Nd, Gd, Dy, Yb, Lu, Sc, La, and mixtures thereof. More preferably, A is selected from the group comprising or consisting of Y, La, Nd, Gd, Dy, Yb, Lu, Sc, and mixtures thereof. Even more preferably, A is selected from the group comprising or consisting of La, Dy, Nd, Yb, and mixtures thereof. Most preferably, A is selected from the group comprising or consisting of La, Nd, and mixtures thereof. A may in particular also be formed by only one of the aforementioned elements, i.e., for example, may only be Y or La or Nd.

B is preferably selected from the group comprising or consisting of Zr, Ti, Hf, Sn, Ge, and/or mixtures thereof. More preferably, B is selected from the group comprising or consisting of Zr, Ti, Hf, and mixtures thereof. According to one embodiment, B is selected from the group comprising or consisting of Zr, Hf, and mixtures thereof. According to a further embodiment, B is selected from the group comprising or consisting of Ti, Hf, and mixtures thereof. B may in particular also be formed by only one of the aforementioned elements, i.e., for example, may only be Zr or Ti.

D is preferably selected from the group comprising or consisting of Nb, Ta, and mixtures thereof. D may in particular also be just one of these elements, for example Nb or Ta.

E is preferably selected from the group of chalcogens, i.e. elements from main group VI (acc. to Mendeleev) of the periodic table of elements (corresponding to IUPAC group 16). E may in particular also comprise mixtures of different chalcogens. E is preferably selected from the group comprising or consisting of selenium Se, oxygen O, sulfur S, and mixtures thereof. More preferably, E is selected from the group comprising or consisting of O, S, and mixtures thereof. Most preferably, E is O (oxygen).

Generally, fillers exhibiting a symmetrical, preferably cubic structure of the individual grains are particularly preferred. What is meant here are cubic structures similar to those of the minerals pyrochlore or fluorite.

Exemplary compositions of fillers can also be found in the following table, the amounts being given in mol % in each case:

TABLE 2

| mol % | Nd₂O₃ | Y₂O₃ | Gd₂O₃ | Yb₂O₃ | Dy₂O₃ | ZrO₂ | Fe₂O₃ |
|---|---|---|---|---|---|---|---|
| PC1 | | | | | | 100 | |
| PC2 | 33.33 | | | | | 66.66 | |
| PC3 | 33.33 | | | | | 44.44 | 22.22 |
| PC4 | | 33.33 | | | | 66.66 | |
| PC5 | | 33.33 | | | | 44.44 | 22.22 |
| PC6 | 38 | | | | | 62 | |
| PC7 | | 38 | | | | 62 | |
| PC8 | 26 | | | | | 74 | |
| PC9 | | 26 | | | | 74 | |
| PC10 | | | 38 | | | 62 | |
| PC11 | | | 26 | | | 74 | |
| PC12 | | | | 38 | | 62 | |
| PC13 | | | | 26 | | 74 | |
| PC14 | | | | | 33.33 | 66.66 | |
| PC15 | | | | | 33.33 | 44.44 | 22.22 |
| PC16 | | | | | 38 | 62 | |
| PC17 | | | | | 26 | 74 | |

Should there be any deviations from the total of 100%, these are due to rounding.

Generally, such fillers with a composition as set forth above are especially advantageous. On the one hand, these are compositions that lie at the point of the mixture dome in the corresponding phase diagram, so that a particularly homogeneous, preferably also very stable crystal phase can preferably be obtained in this way.

Such a composition is furthermore advantageous because such a filler that is added to the paste and thus to the resulting coating in the form of a powder, comes close to the composition of so-called “thermal barrier oxides” or TBO, i.e. substances that are used in so-called “thermal barrier coatings” or thermal insulation layers, for example. It is surprising, however, that the effect of reducing the surface temperature occurs already at very low temperatures of, for example, only 250° C. or even less here (instead of several hundred degrees or above 1000° C.), even if these fillers are not provided in the form of a thermal barrier coating, but also when embedded in a coating matrix such as a glass matrix of an enamel coating, for example. Surprisingly, this effect in particular seems to be due to the fact that the fillers considered here reflect thermal radiation, an effect that is not relevant at all for conventional thermal barrier coatings.

According to one embodiment, the coating is a glass-based coating, preferably an enamel coating.

A glass-based coating is understood to mean that the binder of the coating is or comprises an amorphous, substantially inorganic material, i.e. more than 90 wt % thereof. It is in particular also possible for the binder to be completely inorganic. Inorganic binders exhibit high temperature resistance and are therefore particularly advantageous for hot applications. An amorphous embodiment of the binder is particularly advantageous in order to obtain a smooth, uniform coating. This advantageously increases wear resistance of the coating, such as scratch resistance and/or abrasion resistance.

The glass-based coating is preferably an enamel coating. In the context of the present disclosure, enamel coating is understood to mean a coating which comprises a binder comprising a glass component, in particular a so-called glass flux or glass frit. Here, glass flux or glass frit are glassy, i.e. vitreous materials which are provided in particulate form, as a binder precursor phase, i.e. they initially come in the form of a glass powder, for example, and can also be added to a coating agent such as a paste in powder form. The binder precursor phase forms the binder in the coating. For such glass-based coatings, in particular enamel coatings, the binder may also be referred to as a glass matrix. The enamel coating may in particular be designed such that the glass component at least partially melts when the coating is heated, i.e. in a so-called firing process, so as to bond together and to the substrate the solid constituents of the coating in this way, i.e. the at least one pigment and the at least one filler. It is in particular also possible for the glassy component to melt completely. An implementation of the coating as an enamel coating (or enamel, for short) results in highly adhesive and particularly wear-resistant coatings and is therefore particularly preferred.

What is relevant for ensuring good processability of such an enamel coating, for example, is the softening temperature or softening point (T_{SP_glass powder}) of the glass, because for smooth flow, i.e. in order to produce the coating from the applied paste, the firing temperature must at least correspond to the softening point SP of the glass powder. The softening point SP is the temperature at which the glass has a viscosity of 10^{7.6} dPa·s. Depending on the geometry of the glass element or glass substrate and the heating process, deformations are already observed well below the SP, for example in the case of substrates made of glass. Smooth flow of the glass component to form a layer is advantageous in order to ensure the required chemical, physical, mechanical, and optical properties. Smooth flow is also advantageous for fixing the added one or more pigment(s) and the at least one filler.

In the context of the present disclosure, binder precursor phase is understood to mean a phase which is converted into the binder when curing the wet film applied to the substrate. More particularly, this may refer to a glass powder which melts during firing to form a glass flow or a glass frit or a glass matrix.

According to one embodiment, the glass component of the binder is in the form of a glass flux or glass frit and comprises zinc oxide and/or bismuth oxide. Glass frits with a zinc oxide content in the range from 0.1 to 70 wt % and in particular with a zinc oxide content in the range from 0.1 to 30 wt % have proven to be particularly advantageous. Alternatively or in addition, the glass frit contains 0.1 to 75 wt % and in particular 8 to 75 wt % of bismuth oxide. The content of zinc oxide and bismuth oxide in the embodiments described above has in particular an advantageous effect on the softening point of the glass. According to a refinement of these embodiments, the glass frits have softening points in the range from 500 to 950° C. Preferably, the softening point is less than 800° C., or even below 750° C., and particularly preferably it is below 680° C., but more than 450° C. The low softening points provide for the formation of a homogeneous glass matrix from the glass powder already at low firing temperatures. This makes it possible to coat glass or glass ceramic substrates of different compositions (and thus different softening points) with the paste without lowering the viscosity of the glass or glass ceramic substrate to be coated or of the resulting glass or glass ceramic element during the firing.

Moreover, the bismuth oxide content in the glass increases the chemical resistance of the corresponding coating, i.e. the coating made from the paste.

Since the glass matrix in the coating of the coated substrate (or element) has the same composition as the glass powder in the paste, the specifications regarding the composition of the glass powder also apply correspondingly to the composition of the glass matrix in the coating according to some embodiments or refinements. The glass matrix may also be considered as a binder or binder phase of the coating.

According to one embodiment of the invention, the glass powder in the paste and the glass matrix of the corresponding coating have the following composition, in wt %:

| SiO₂ | 30-75, preferably 44-75 |
|---|---|
| Al₂O₃ | 0-25, preferably 0.2-25, more preferably 2-25 |
| B₂O₃ | 0-30, preferably 1-30, more preferably 5-30 |
| Li₂O | 0-12 |
| Na₂O | 0-25, preferably 0-15 |
| CaO | 0-12 |
| MgO | 0-9 |
| BaO | 0-27 |
| SrO | 0-4 |
| ZnO | 0-35, preferably 0-20 |
| Bi₂O₃ | 0-5 |
| TiO₂ | 0-10, preferably 0-5 |
| ZrO₂ | 0-7 |
| As₂O₃ | 0-1 |
| Sb₂O₃ | 0-1.5 |
| F | 0-3 |
| Cl | 0-1, preferably free of Cl, except for unavoidable traces |
| H₂O | 0-3. |

The glass preferably has a minimum Al₂O₃ content of 0.2 wt %, preferably of at least 2 wt %. Alternatively or additionally, the glass has a B₂O₃ content of at least 1 wt %, preferably at least 5 wt %.

It has furthermore been found to be advantageous if the glass contains at least 1 wt % of an alkali oxide selected from the group consisting of Na₂O, Li₂O, and K₂O or mixtures of these oxides.

Alternatively or additionally, the glass comprises at least 1 wt % of a further oxide or of a mixture of oxides selected from the group consisting of CaO, MgO, BaO, SrO, ZnO, ZrO₂, and TiO₂.

According to a further embodiment, the glass has the following composition, in wt %:
SiO₂ 6-65, preferably 10-65, more preferably 15-65
Al₂O₃ 0-20
B₂O₃ 0-40, preferably 1-30, more preferably 3-30
Li₂O 0-12
Na₂O 0-18
K₂O 0-17
CaO 0-17
MgO 0-12
BaO 0-38
SrO 0-16
ZnO 0-70
TiO₂ 0-5
ZrO₂ 0-5
Bi₂O₃ 0-75, preferably 0-60, more preferably 5-60, most preferably 10-60
CoO 0-5
Fe₂O₃ 0-5
MnO 0-10
CeO₂ 0-3
F 0-3
Cl 0-1
H₂O 0-3.

In a preferred implementation of the embodiment, the glass has a minimum SiO₂ content of 10 wt %, preferably at least 15 wt %. As an alternative or in addition, the glass has a minimum Bi₂O₃ content of 5 wt %, preferably of at least 10 wt %. Alternatively or additionally, the glass contains at least 1 wt %, preferably at least 3 wt % of B₂O₃. The total content of alkali oxides Na₂O, Li₂O, and K₂O is preferably at least 1 wt %.

The glass included in the paste or the glass matrix in the respective coating may in particular be an alkali-free glass, an alkali-containing glass, a silicate glass, a borosilicate glass, a zinc silicate glass, a zinc borate glass, a zinc borosilicate glass, a bismuth borosilicate glass, a bismuth borate glass, a bismuth silicate glass, a phosphate glass, a zinc phosphate glass, an aluminosilicate glass, or a lithium aluminosilicate glass. According to one embodiment of the invention, the paste includes glass powders with different glass compositions.

According to one embodiment, the glass has a content of the toxicologically questionable components lead, cadmium, mercury, and/or chromium(VII) compounds of less than 500 ppm.

According to a further embodiment, the pigment is in the form of an absorption pigment. In other words, it is a pigment that imparts a color through absorption. This is in contrast to so-called effect pigments which in particular give a material or a coating a certain visual appearance (for example a so-called metallic effect), and to the white pigments which do not impart a color due to absorption in the visible, but mainly cause a white color (or in a pigment mixture possibly a lightening effect) due to scattering effects.

The pigment is preferably in the form of an absorption pigment and has a black or black-brown color. For example, the pigment may come in the form of an IR-reflecting absorption pigment. More particularly, the IR-reflecting pigment may be selected from the group of pigments consisting of C.I. Brown 29, C.I. Green 17, and C.I. Black 7. TABLE 3 below lists suitable IR-reflecting pigments 1 to 4. Pigment 5 is a non-IR reflecting absorption pigment. Also, a non-reflecting absorption pigment may, for example, be a copper chromite spinel black (C.I. pigment Black 28).

TABLE 3

| | | | | | Mean size | |
|---|---|---|---|---|---|---|
| Pigment | | | Density | BET | (d₅₀) | TSR |
| # | Color Code | Composition | [g/cm³] | [m²/g] | [μm] | [%] |
| 1 | C.I. Brown | chromium iron | 5.2 | 1.9 | 1.1-1.6 | 25 |
| | 29 -1 | oxide | | | | |
| 2 | C.I. Brown | chromium iron | 5.4 | 2.9 | 0.97-1.2 | 27 |
| | 29 - 2 | oxide | | | | |
| 3 | C.I. Green | chromium | 5.2 | 2.7 | 1.1-1.4 | 25 |
| | 17 | green-black | | | | |
| | | hematite | | | | |
| 4 | C.I. Brown | chromium iron | 5.1 | 3 | 1.11-1.3 | 29 |
| | 29 - 3 | oxide | | | | |
| 5 | C.I. Black | chromium iron | 5.3 | 3 | 1.1 | 13 |
| | 30 | nickel black | | | | |
| | | spinel | | | | |

An implementation of the pigment in the form of an absorption pigment is particularly advantageous in hot applications. This is because on the one hand, implementing the pigment in the form of an absorption pigment makes it possible to at least partially decouple the opacity and coloration caused by the pigment from the grain size. This is different for white pigments, for example, in which case the grain size is an essential factor for achieving a scattering effect and hence a sufficient covering effect. Especially in the case of white pigments this might imply a conflict of objectives between sufficient scattering (and hence white coloring) of a coating in the range of visible light and sufficient scattering in the range of thermal radiation and consequently also a reflective effect thereby. This means that in the case of absorption pigments the grain size can in particular be selected under other aspects, and aspects such as in particular processability and the influence of rheology on the particle size can also be taken into account when choosing the grain size. Moreover, it is still possible in this way to realize the usual layer thicknesses for a coating on a glass substrate or glass element with a sufficient covering effect of the coating. This is also particularly advantageous for hot applications, because in this way it is not only possible to clearly identify functional areas of an appliance equipped with such a glass element, for example, but also allows to ensure sufficient mechanical strength of the glass element despite a coating, even if the glass element is subjected to thermomechanical stresses during operation. In fact, it is known that the mechanical strength of a glass element generally decreases with increasing thickness of a coating. This is in particular true for highly adhesive coatings, especially glass-based coatings, and specifically enamel coatings. The latter are usually particularly well bonded to the substrate surface by a melting reaction zone, and this is precisely why they may impair the mechanical strength to a particularly high degree.

According to a further embodiment, the pigment comprises pigment particles with a size distribution with a d₅₀ value of the equivalent diameter in a range between 0.15 μm to 2 μm, preferably in the range from 0.5 μm to 1.8 μm, for example in the range from 0.8 μm to 1.8 μm. In this way, good processability of the paste is ensured. Furthermore, this also allows to achieve a good resolution in the case of a laterally patterned application of the coating on at least one side (or main surface) of the glass substrate.

Here, laterally patterned application is understood to mean that at least one area of a main surface of the substrate or of the element has no coating, whereas another area has or is provided with the coating. More generally, in this case, it is possible for the coating to be applied such that there are a plurality of areas that have no coating and/or a plurality of areas that are coated, for example in the form of a dot raster pattern.

In fact, the small particle size allows the paste to be applied even with close-meshed screens, for example with screens having a thread count of 77 threads per cm or even 100 threads per cm or more, such as 120 threads per cm, so that the paste can be used to produce coatings or decorations with high graphic resolution by screen printing. By way of example, but not limiting, the TABLE 4 below lists some suitable screens.

TABLE 4

| Screen designation | | Number of | Thread diameter, | Mesh size |
|---|---|---|---|---|
| in the text | | threads (cm⁻¹) | nominally (μm) | (μm) |
| 77 | T | 77 | 55 | 67 |
| 90 | T | 90 | 48 | 55 |
| 100 | T | 100 | 40 | 37 |

Furthermore, the layer thickness of the coating after the firing process is determined by the mesh size of the employed screen in combination with the oil content included in the paste and the powder densities of the powders included in the paste.

According to a further embodiment, it is in particular possible for the pigment to comprise pigment particles with a specific surface area in a range from 1.1 m²/g to 8 m²/g, preferably in the range from 1.8 m²/g to 4.5 m²/g. In other words, the pigment particles do not have a particularly large surface area, based on the weight, as it may be the case with certain filler particles, for example. Therefore, these pigment particles will usually have only very little impact on the rheology of a paste. Furthermore, this also optimizes the consumption of binder. This is because the binder should be sufficient to bind the particles contained in the coating, in particular the pigment particles, for example by enveloping the particles or their surface as completely as possible. Therefore, the requirement for binder and possibly also for liquid constituents of the paste usually increases with the surface area of the particles contained in the coating or in a coating agent such as a paste. However, at the same time the surface area of the particles should not be too small in order to ensure sufficient contact between the binder and the one or more particle(s), which allows to improve the embedding of the particles in the coating and consequently the mechanical durability thereof.

It is furthermore also possible and may even be preferred for the coating to comprise a further pigment. The further pigment may in particular be an IR-reflecting pigment. Therefore, according to embodiments, the coating may comprise two IR-reflecting pigments, but it is also possible that none of the pigments is designed to be IR-reflecting or that only one is IR-reflecting. The second pigment in particular allows to adjust the color location of the coating. Preferably, the coating includes an IR-reflecting pigment as the second pigment, in particular a cobalt chromite spinel, an indium manganese yttrium oxide, a niobium sulfur tin oxide, a tin zinc titanate, and/or a cobalt titanate spinel. It has been found to be particularly advantageous to use any one of the pigments selected from the group consisting of C.I. pigment Blue 36, C.I. pigment Blue 86, C.I. pigment Yellow 227, C.I. pigment Yellow 216, C.I. pigment Green 26, and C.I. pigment Green 50.

According to one embodiment, the volume ratio of the volume of the second pigment to the volume of the first pigment is 0.03 to 0.6, preferably 0.05 to 0.56, and most preferably 0.14 to 0.47.

According to a further embodiment, the filler comprises filler particles with a size distribution with a d₅₀ value of the equivalent diameter between 0.15 μm and 25 μm. It has been found that such an embodiment of the filler or of the coating or the corresponding paste is particularly advantageous. In particular, it has been found that in order to achieve the lowest possible surface temperature on a glass or glass ceramic element that is provided with a coating according to embodiments, the particle size should in particular not be smaller than a certain minimum particle size. Preferably, the particle size of the filler particles is between 0.15 μm and 25 μm, more preferably between 0.2 μm and 25 μm, most preferably between 0.5 μm and 5 μm.

The reason for this is not fully understood. The inventors assume that a certain minimum particle size might be necessary for the advantageous thermal properties of the filler to take effect at all. One reason for this could be, for example, that the thermal properties, in particular heat capacity, are material properties which may be influenced by the arrangement of the atoms or ions and the resulting degrees of freedom in the lattice of the solid. In the case of nanoparticles that have a large specific surface area so that surface properties correspondingly play a more important role than volume effects, a negative impact in terms of the resulting degrees of freedom of lattice vibrations could be resulting with regard to the presently addressed effect of temperature reduction of a coated glass or glass ceramic element. Therefore, the particle size of the filler particles, based on the d₅₀ value of the size distribution of the equivalent diameter, should not be too small and is at least 0.2 μm according to one embodiment, preferably at least 0.8 μm.

However, in order to achieve a good resolution, for example when the coating is applied in a screen printing process, and/or for good processability, the particle size should not be too large on the other hand and is therefore limited to at most 25 μm according to one embodiment, most preferably to at most 5 μm.

According to one embodiment, the fraction of the pigment in the solids content of the coating is between 7 vol % and preferably at most 43 vol %.

According to one embodiment, the fraction of the filler in the solids content of the coating is at least 1 vol % and preferably at most 15 vol %, preferably between at least 1.5 vol % and at most 5 vol %.

According to one embodiment, the coating comprises a binder, and the fraction of the binder in the solids content is at least 50 vol % and preferably at most 85 vol %.

In the context of the present disclosure, if the coating and/or the corresponding paste comprises a further pigment in addition to the first pigment, the fraction of the pigment in the solids content refers to the respective total of pigments. The same applies to the ratio of pigment to filler.

According to one embodiment, the material the pigment is made of is or comprises an inorganic material, preferably a high temperature stable inorganic material, in particular a high temperature stable inorganic oxidic material. Thus, the pigment may therefore come in the form of an inorganic oxidic pigment which is stable at high temperatures.

According to one embodiment, the pigment comprises a chromium-containing pigment, preferably a chromium-containing iron oxide, for example a chromium-containing hematite and/or a chromium-containing spinel, or is made of such a material.

Such pigments exhibit particularly high thermal stability and high chemical inertness in particular with respect to the glass constituents of the glass powder in the paste, which is particularly advantageous in view of the firing of the paste for producing the corresponding enamel coating. Thus, according to one embodiment, the maximum possible firing temperature is not limited by the stability of the pigments. In a refinement of the invention, this allows the paste on a glass or glass ceramic substrate to be fired at high temperatures in the range from 500° C. to 1000° C., so that it is possible for a glass substrate, for example, to be thermally toughened during the firing process of the coating, so that a thermally toughened glass element is resulting.

According to one exemplary embodiment of the invention, the glass powder contained in the paste has a particle size distribution of the equivalent diameter with a d₅₀ value in a range from 0.1 μm and 3 μm and in particular in a range between 0.1 μm and 2 μm. Such particle sizes ensure a homogeneous distribution of the pigment and filler particles in the coating and the formation of a largely homogeneous glass layer during the firing process.

According to a further embodiment, the substrate is a glass substrate and preferably is made of or comprises a soda-lime glass or a borosilicate glass. In this case, the coating may most preferably comprise ZrO₂ as the filler, in particular also in the form of cubically stabilized ZrO₂. Also, the glass element may in particular be provided in a thermally toughened state in this case. Such an implementation can be advantageous because in this way an element is provided which can be manufactured using readily available components. Such an embodiment can be particularly advantageous for an application of the glass element in an oven door, i.e. as a so-called “oven door pane”.

According to a further embodiment, the glass or glass ceramic substrate has a sheet-like shape, for example in the form of a planar or curved or arched sheet.

According to a further embodiment, the glass or glass ceramic substrate has a thickness between at least 1 mm and at most 10 mm, preferably between 2 mm and 8 mm.

According to a further embodiment, the coating comprises at least one absorption pigment and has a thickness between at least 2 μm and 20 μm, preferably from 3 μm to 15 μm. The wet film thickness of the corresponding coating comprising at least one absorption pigment, i.e. the thickness of the coating agent or paste applied to the substrate, is preferably between 8 μm and 35 μm, more preferably between 10 μm and 20 μm.

According to a further embodiment, the ratio of pigment to filler in the coating is at least 0.75:1 and preferably at most 12.5:1, based on the volume, most preferably between 1.5:1 and 8:1.

According to a further embodiment, the coating has been or is applied such that at least one area of a main surface of the glass or glass ceramic substrate has the coating and at least one area of the main surface of the glass or glass ceramic substrate is not covered by the coating, and preferably at least 60%, more preferably at least 65%, and most preferably at least 70% of the respective main surface has the coating, and preferably at most 95% of the main surface is coated with the coating. The coating may preferably be applied in the form of a raster pattern such as a dot raster, and/or in the form of a frame. Raster pattern is to be understood here as a pattern of dots that are regularly distributed over an area and can be understood, for example, as the corner points of intersecting right-angled lines of a grid. In the context of the present disclosure it is possible for a dot raster that the size of the dots and/or the density of the dots in the surface area to be coated changes gradually or section-wise.

For example, it is possible and may even be preferred that the coating is applied so as to entirely cover the main surface of the glass or glass ceramic substrate in a peripheral area in the form of a frame, and so that the degree of coverage of the surface area of the main surface by the coating decreases towards the center of the main surface, with the frame transitioning into a dot raster with an initially high degree of coverage and with the raster pattern changing towards the center by exhibiting a decreasing degree of coverage by the dot raster. Here, degree of coverage is understood to mean the ratio of the coated surface area or areas of the main surface of the glass or glass ceramic substrate or of the glass or glass ceramic element, respectively, to the total surface area of the main surface of the glass or glass ceramic element or substrate.

Thus, the degree of coverage results as the ratio of the sum of the surface areas of a main surface covered with the coating compared to the entire main surface of the glass or glass ceramic element or, correspondingly, of the glass or glass ceramic substrate. In other words, more generally, the degree of coverage is calculated as the ratio of coated surface area to the total surface area of the considered main surface. Here, the coated surface area is the covered surface area or, in the case of a plurality of such surface areas, the total surface area of these surface areas.

The presence of the coating in the form of a frame may be particularly preferred because, for example, it is possible in this way to at least partially mitigate or reduce direct contact of the surface with sharp-edged or abrasive items or components in an installed state of the element—for example with a metal frame or metallic components in the form of mounting means. That is, in the peripheral area the coating can then be effective as a kind of scratch protection coating. Since scratches in the surface of a glass or glass ceramic substrate or of a glass or glass ceramic element reduce the mechanical strength thereof, such a design in which the coating defines a frame in the peripheral area will therefore be advantageous.

The coating may also be effective as a scratch or wear protection coating in the remaining areas of the element. The surface areas of the element covered by the coating are in fact somewhat elevated compared to the non-covered areas, so that the coating acts as a kind of spacer relative to the surface in this case. Although scratches on the surface cannot be completely prevented in this way, they can at least be reduced somewhat. However, the degree of coverage should not be too high in the central area of the element, since such coated elements may for instance also be used as a viewing window, for example in an oven door. Hence, a tradeoff has to be found here between sufficient coverage for the preferably targeted mitigation of surface damage and sufficient free surface area to allow to look through the element.

Preferably, the degree of coverage is at least 60%, preferably at least 65%, and most preferably at least 70%. The degree of coverage should preferably not be greater than 90%.

According to a further embodiment, no further coating is disposed on the side of the glass or glass ceramic substrate on which the coating is disposed, and/or the content of the coating of conductive oxides, in particular of conductive oxides selected from the group of oxides consisting of indium tin oxide, fluorine tin oxide, aluminum zinc oxide, and antimony tin oxide is smaller than 500 ppm, based on the weight.

Another aspect of the present disclosure relates to a paste. The paste can be used to produce a coating on a glass or glass ceramic substrate for producing a glass or glass ceramic element according to embodiments. It comprises a binder precursor phase, at least one pigment and at least one filler, and the binder precursor phase preferably is or comprises a glassy material, the at least one pigment preferably comprises an IR-reflecting material, and the at least one filler comprises a material having a specific molar heat capacity of not more than 5 mJ/(mol·K) and preferably a thermal conductivity of not more than 12 W/(m·K).

According to a further aspect, as an alternative or in addition, the paste may be designed so as to comprise at least one binder precursor phase, at least one pigment, and at least one filler, with the binder precursor phase preferably being or comprising a glassy material, and so that the at least one pigment preferably comprises an IR reflecting material and the filler comprises zirconium oxide and/or an oxide of a rare-earth element.

In addition to the solids, that is the at least one pigment, the at least one filler, and the at least one binder precursor phase, the paste also comprises a volatile constituent, for example a solvent or a mixture of solvents. The volatile constituent may in particular be in the form of a screen printing medium. The volume fraction of the volatile constituent in the paste is preferably between 40 vol % and 80 vol %.

The filler preferably is or comprises ZrO₂, in particular cubically stabilized ZrO₂, more particularly cubic stabilized ZrO₂ that comprises HfO₂, and/or is or comprises a chalcogenide, in particular an oxide, according to the following formula:

A_{2+X}B_{Y}D_{Z}E₇,

wherein A is at least one element from the group of rare earth elements and is present as a trivalent cation, B is at least one element which is present as a tetravalent cation, D is at least one element which is present as a pentavalent cation, and E is at least one element which is present as a divalent anion, and wherein:

0≤X≤1.1;

0≤Y≤3;

0≤Z≤1.6;

and wherein furthermore the following applies:

8≤3X+4Y+5Z≤15.

According to one embodiment of the invention, the paste comprises 10 to 40 wt % of IR-reflecting pigments, 2.5 wt % to 25 wt % of filler, 45 to 85 wt % of glass powder, and 12 to 35 wt % of solvent. Solvents that are preferably used for screen printing coating solutions include solvents with a vapor pressure of less than 10 bar, in particular less than 5 bar, and most preferably less than 1 bar.

Such solvents or solvent mixtures may also be referred to as screen printing medium or screen printing oil. These may be combinations of water, n-butanol, diethylene glycol monoethyl ether, tripropylene glycol monomethyl ether, terpineol, n-butyl acetate, for example. Appropriate organic and inorganic additives are used in order to be able to adjust the desired viscosity. Organic additives may include hydroxyethyl cellulose, and/or hydroxypropyl cellulose, and/or xanthan gum, and/or polyvinyl alcohol, and/or polyethylene alcohol, and/or polyethylene glycol, block copolymers, and/or triblock copolymers, and/or tree resins, and/or polyacrylates, and/or polymethacrylates, for example. It is possible to use common commercially available screen printing oils.

The composition of the paste as described above ensures that a coating produced therefrom exhibits high IR reflectance. At the same time, the proportion of screen printing medium ensures good processability of the paste, in particular for processing by screen printing. The paste therefore preferably has a viscosity in the range between 3.5 Pa·s at a shear rate of 200 per sec. and 15 Pa·s at a shear rate of 200 per sec., most preferably in the range from 4.8 Pa·s at a shear rate of 200 per sec. to 12.8 Pa·s at a shear rate of 200 per sec.

Yet another aspect is directed to an oven pane for an oven door. Generally, an oven door comprises an assembly of panes. Such a pane assembly may comprise at least two glass elements and/or glass substrates. An advantageous pane assembly comprises at least one glass element according to an embodiment, and the glass element according to the embodiment preferably is the outer pane of the pane assembly. Outer pane refers to the pane of the pane assembly that faces the user during operation of the oven. This may in particular be the pane to which a handle is connected or at least can be connected or which is designed so that is can be connected thereto. In the context of the present disclosure, oven door pane is generally understood to mean a pane, i.e. a sheet-like glass or glass ceramic element or glass or glass ceramic substrate, preferably a sheet-like glass element or substrate that is intended and/or suitable for being installed in an oven door.

The oven door pane according to one embodiment comprises a glass element according to one embodiment, and the glass element comprises the coating on only one main surface, the coating being applied in a laterally patterned manner, wherein preferably at least 60%, more preferably at least 65%, and most preferably at least 70% of the main surface of the glass element is covered by the coating, and wherein most preferably the glass element comprises no further coating made of a transparent conductive oxide, and wherein the glass element is preferably provided in the form of a toughened glass element.

The present disclosure also relates to a fireplace pane comprising or made of a glass ceramic element according to embodiments.

Yet another aspect is directed to a method for producing a glass or glass ceramic element according to embodiments, which comprises the steps of: providing a transparent glass or glass ceramic substrate, providing a paste, in particular a paste according to embodiments, which comprises a glass powder that has a softening point SP_{glass_powder}, which SP_{glass_powder} is below the deformation temperature of the substrate material, at least one IR-reflecting pigment, and a screen printing medium, applying the provided paste onto at least one main surface of the provided glass or glass ceramic substrate in a laterally patterned manner by screen printing so as to obtain a wet layer of the coating, firing the wet layer at temperatures in a range of T_{firing}>T_{g_glass_powder}, to form the coating, wherein, preferably, the substrate is a glass substrate, most preferably a soda-lime glass or a borosilicate glass, and the glass substrate is thermally toughened concomitantly with the firing of the applied coating, and/or wherein, preferably, the firing temperature is in the range from 500° C. to 1000° C., preferably in the range from 500° C. to 700° C., and/or wherein, preferably, the substrate is a crystallizable green glass and ceramization of the green glass is achieved concomitantly with the firing of the coating, and/or wherein the firing of the coating is accomplished in a pattern-preserving manner, and/or wherein the paste comprises an absorption pigment, and the thickness of the wet layer is at least 8 μm and at most 35 μm, preferably at least 10 μm and at most 20 μm.

Here, pattern-preserving firing is understood to mean that the coating applied in a laterally patterned manner so as to obtain non-covered areas and areas covered by the coating is preserved during the firing process.

### Examples

The technical effect of lowering the surface temperature of a glass or glass ceramic element comprising the coating can be demonstrated, for example, on a pane assembly as it is known from oven doors, for example. In the context of the present disclosure, a glass or glass ceramic element that is used in an oven door or in a pane assembly for an oven door may also be referred to as an oven door pane. For short, such a glass or glass ceramic element may also be referred to as an “oven pane”, which will always refer to an oven door pane. As far as an outer oven pane (or oven door pane) is referred to in the context of the present disclosure, this means that glass or glass ceramic element which faces a user when an oven door is used as intended. Depending on the exact structure of the oven door, the outer glass or glass ceramic element may be designed differently than the other glass or glass ceramic elements or substrates of the pane assembly. For example, the outer glass or glass ceramic element may have a different size, for instance in order to enable installation in a frame or in order to cooperate with a seal of an oven muffle, or the outer element may have, mounted thereto, components for opening purposes such as a door handle.

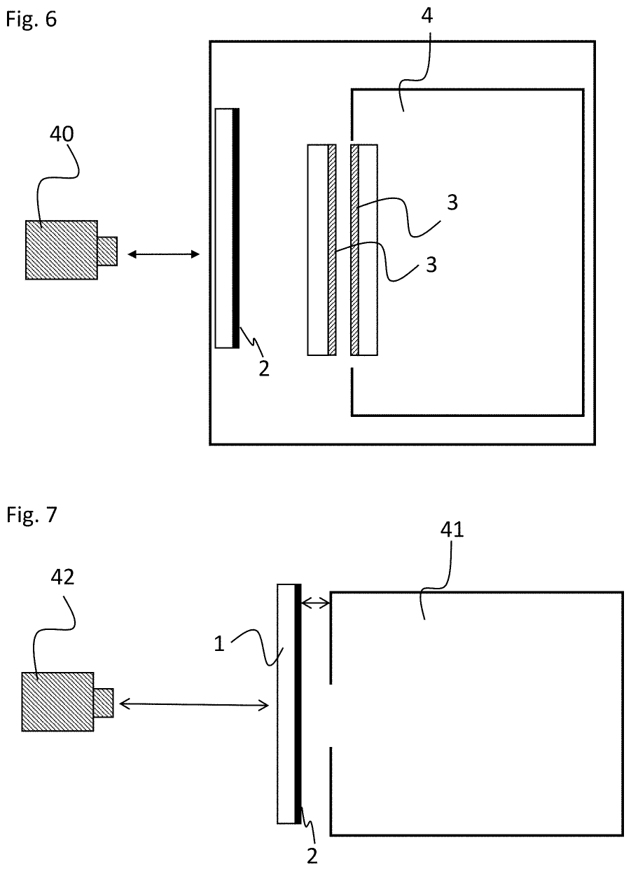

For determining the outside temperature on such an outer glass element, a setup as described in international patent application WO 2019/101873 A1 is appropriate, for example. For this purpose, an element according to one embodiment, in particular a glass element, is installed into an oven door, as an outer pane. The temperature on the outer surface of the element is determined using an IR camera, and for this purpose a respective IR thermal image is captured at intervals of one minute. In the setup as described in WO 2019/101873 A1, the distance between the thermal imaging camera and the outer pane of the oven door is 203.2 cm. The oven volume was 28.317 l, or 5.3 ft³. The measurements are taken for an internal temperature of the oven of 875° F., i.e. 468° C., and of 475° F., i.e. 246° C. in each case. Such a measurement setup can be seen in the schematic view of FIG. 6 that will be described further below.

Alternatively, a determination using a laboratory measurement setup is possible as well, also as described in WO 2019/101873 A1. Here, the respective surface temperatures of the panes were determined using a pyrometer 42 (impac, IE 120/82L), the focal point was placed on the outer surface of the decorated pane, and a respective reading was captured every minute. The distance of the pyrometer 42 to the outer pane of the oven door was 50 cm. The volume of the oven was 30×12×12 cm³ in the test setup. The distance between the decorated pane and the oven was 2 cm here, and the opening of the oven had a diameter of 3 cm. The measured panes were coated over the entire surface thereof. Such a laboratory setup is also schematically illustrated further below, in FIG. 7.

When coatings according to embodiments are measured together with coatings according to WO 2019/101873 A1 in one of the two aforementioned measurement setups, for example, and the measurement results are compared with one another, it is found that the outside temperature of the outer pane or of the outer glass element according to embodiments of the present disclosure can further be reduced.

For example, when a coating is produced using a paste which in addition to 17.5 vol % of an IR-reflecting pigment additionally comprises 1.4 vol % of a filler, here ZrO₂, the outside temperature of the glass element that is provided with a coating obtained with such a paste can be further lowered by about 2° C. compared to a glass element in which the coating only comprises an IR-reflecting pigment. The coated side of the glass element faces the interior of the oven in this case. The particle size of the filler was 20 μm here (given as the d₅₀ value of the equivalent diameter).

With a paste comprising 15 vol % of an IR-reflecting pigment and 2.5 vol % of a mixed oxide that comprises ZrO₂ and an oxide of a rare-earth element, the outside temperature can even be lowered by 4° C. compared to a glass element in which the coating only includes the respective IR-reflecting pigment. The coated side of the glass element faces the interior of the oven in this case. The particle size d₅₀ of the filler was about 1 μm here (given as the d₅₀ value of the equivalent diameter). The filler had the composition Nd₂Zr₂O₇ in this case.

However, surprisingly, it has been found here that such a high reduction in the outside temperature also depends on the particle size of the employed filler. If, for example, the particle size of Nd₂Zr₂O₇ is reduced and is only 50 nm (based on the d₅₀ value of the equivalent diameter), a reduction by only 1.5° C. can be determined, with otherwise the same filler content in the paste and in the resulting coating.

In addition, it has been found that other properties of the coating, such as impermeability of the coating to the passage of fluids, might also be affected by the addition of a nano-sized filler comprising a mixed oxide which comprises or is made of an oxide of a rare-earth element and ZrO₂ and/or HfO₂. If, for example, a nano-sized Nd₂Zr₂O₇ filler is used, the resulting coating is not sufficiently impermeable. This means that, for example, liquids can penetrate the coating. This can not only be visually disruptive, but may also lead to damage to the coating, for example in the case of aggressive cleaning agents and/or when the coating is heated.

Thus, it has been found that in particular particle size distributions of the equivalent diameter with a d₅₀ between 0.15 μm, preferably 0.25 μm, most preferably 0.5 μm, and 5 μm are particularly advantageous in order to obtain coatings according to embodiments. Larger particles may also be used, but might lead to rougher coatings. Also, in the case of a laterally patterned application of the coating, the resolution may possibly be reduced. More generally, the filler may comprise filler particles with a size distribution with a d₅₀ value of the equivalent diameter in the range between 0.15 μm and 25 μm, preferably in the range from 0.2 μm to 25 μm, most preferably from 0.5 μm to 5 μm.

TABLE 5 below lists various suitable fillers or materials that are contained in suitable fillers or can form the filler.

TABLE 5

| | Thermal | Specific molar heat |
|---|---|---|
| | conductivity | capacity |
| Material | [W/(m · K)] | [mJ/(mol · K)] |
| TiO₂ | 3-4 | 8.76 |
| Y₂O₃ | 8-12 | 1.99 |
| ZrO₂ | 1.5-3 | 3.65 |
| La₂Zr₂O₇ | 2 | 0.61 |
| Gd₂Zr₂O₇ | 1.8 | 0.69 |
| Nd₂Zr₂O₇ | 1.25 | 0.69 |
| La₂Hf₂O₇ | 1.93 | 0.52 |
| 8YSZ | 2.09 | 4.18 |

Here, 8YSZ stands for ZrO₂ stabilized with 8 mol % of Y₂O₃.

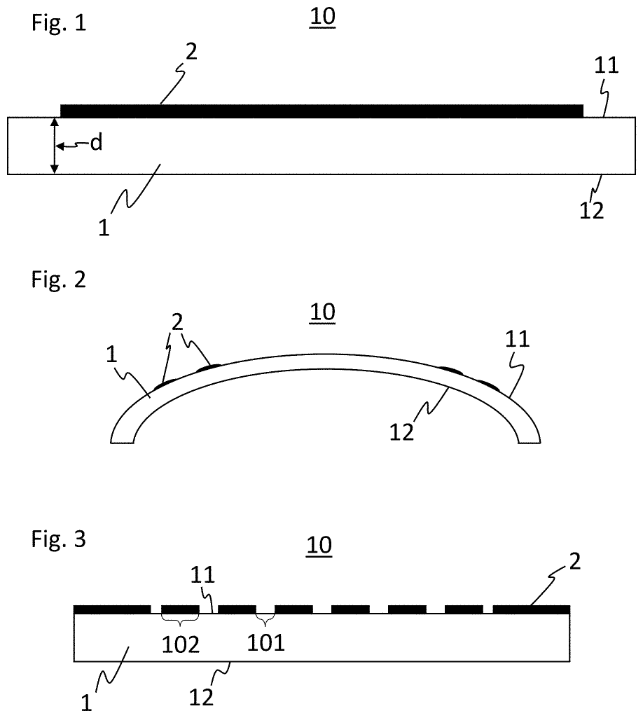

FIG. 1 shows a first schematic view, not drawn to scale, of a glass or glass ceramic element 10 for a household and/or heating appliance, which comprises a sheet-like transparent glass or glass ceramic substrate 1. Sheet-like substrate 1 is planar here, that is, it is not curved. Substrate 1 has a first surface 11 and a second surface 12 opposite the first surface 11. The surfaces may also be referred to as sides or faces and constitute so-called main surfaces of the glass or glass ceramic substrate 1 or, correspondingly, of the glass or glass ceramic element 10, because together they make up more than 50% of the surface of the substrate. Furthermore, the thickness d of the glass or glass ceramic substrate 1 is indicated. Here, the thickness of the glass or glass ceramic substrate 1 can approximately also be assumed to be the thickness of the glass or glass ceramic element 10, because, unlike illustrated in the view for the sake of better comprehension, the thickness of the coating 2 (not designated) is only very small in comparison to the thickness of the glass or glass ceramic substrate 1. The coating 2 is disposed at least in some area on at least one of the main surfaces 11, 12, here in fact on main surface 11 of substrate 1. This is to be understood as meaning that the coating 2 does not need to cover the entire main surface 11, but may rather be applied only in an area, so that another area of the main surface will not be covered by the coating 2. Here, the coating is disposed in a central area of the main surface 11, so that a peripheral area remains free. However, full surface coverage is also possible, as a matter of course. Furthermore, it is also possible for the coating to be disposed not only on one main surface, but on both main surfaces 11, 12 of the substrate. The coating 2 comprises at least one pigment, which is in the form of an IR-reflecting pigment, and at least one filler, the at least one filler comprising a material having a specific molar heat capacity of not more than 5 mJ/(mol·K) and preferably a thermal conductivity of not more than 12 W/(m·K). According to a further aspect, the coating 2 may also be described as comprising at least one pigment and at least one filler, the pigment being an IR-reflective pigment and the filler being or comprising zirconium oxide and/or hafnium oxide and/or an oxide of a rare-earth element. The coating 2 is in the form of a glass-based coating, preferably an enamel coating.

FIG. 2 shows a further schematic view, not drawn to scale, of an embodiment of a glass or glass ceramic element 10, here comprising a sheet-like transparent glass or glass ceramic substrate 1. Here, again, the sheet-like substrate 1 has two main surfaces 11, 12 opposite to one another, and the coating 2 is disposed on areas of one of the main surfaces 11, 12, namely on main surface 11 in this case. The sheet-like substrate 1 is in the form of a curved sheet here. More generally, without being limited to the example illustrated here, it is possible that both main surfaces 11, 12 have a coating 2 at least in some areas thereof.

FIG. 3 shows yet another view of an embodiment of a glass or glass ceramic element 10 according to one embodiment, for a more detailed explanation of a laterally patterned application of the coating 2. Here, the glass or glass ceramic element 10 is designed so that the coating 2 is applied in a laterally patterned manner. This means that at least one area 101 of the main surface 11, 12 of the substrate 1, here main surface 11, has no coating 2, whereas another area 102 is provided with the coating 2. Here again, more generally, it is possible for the coating 2 to be applied on both sides. More generally, without being limited to the exemplary embodiment of a glass or glass ceramic element 10 as shown in FIG. 3, it is in particular possible for the coating 2 to be applied such that a plurality of areas 102 and/or a plurality of areas 101 are provided.

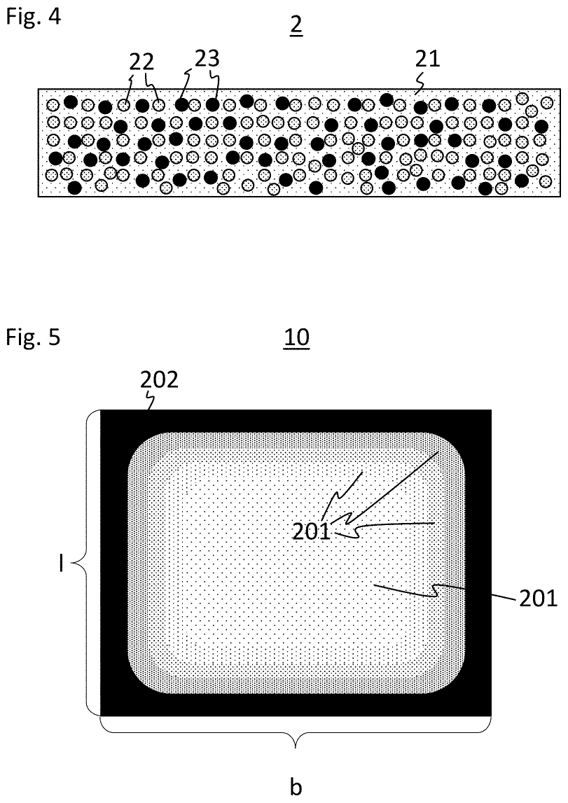

FIG. 4 shows a schematic sectional view of a coating 2, not true to scale. The coating 2 is designed so as to comprise pigment particles 22 and filler particles 23. Furthermore, the coating comprises the binder 21. This binder 21 may in particular be glass-based, the coating 2 may preferably be an enamel coating, i.e. comprising a glassy component which at least partially melts when heated and surrounds the particulate constituents included in the coating and bonds them to one another and to the substrate 1.

The embodiment of the coating 2 as shown in FIG. 4 is a particularly preferred embodiment. That is, in the present case the pigment particles 22 and the filler particles 23 are shaped so as to have quite similar particle sizes. Generally, preferred particle sizes of the pigment are less than 10 μm, in particular between 0.15 μm and 2 μm. The pigment particles may, for example, have a size distribution with a d₅₀ value of the equivalent diameter in the range between 0.5 μm to 1.8 μm, for example from 0.8 μm to 1.8 μm. The filler particles 23 may generally have particle sizes between 50 nm and up to 25 μm. However, very small particle sizes of less than 0.1 μm are not preferred, because it has been found that with nanoscale fillers the effect of minimizing the temperature on the viewing window can in fact be observed, but is less pronounced than with larger particle sizes. Although filler particles can also be used up to 25 μm (based on the d₅₀ value of the equivalent diameter), this is however not preferred for reasons of processability. Also, rather rough coatings are obtained with such large filler particles. This can be disadvantageous. In fact, in the present case the fillers are designed so as to comprise hard particles, so that a reduction in wear resistance of the coating as caused by a rough surface which offers more contact surface for cleaning scrapers, for example, is less likely here. However, materials that come into contact with the coating might be damaged. Moreover, the use of large particles leads to a poorer resolution in a screen printing process, because of the larger mesh size that is required for this purpose, for example.

In addition, the use of particles which are at least approximately of the same size can be advantageous for achieving the best possible distribution of the pigment particles in the coating. This can be advantageous for the covering effect of the coating.

Finally, FIG. 5 shows a plan view of an exemplary glass or glass ceramic element 10 according to one embodiment. Glass or glass ceramic element 10 or, correspondingly, glass or glass ceramic substrate 1 (not designated here) has a length l and a width b. The coating 2 is disposed on one main surface of the substrate in a laterally patterned manner, here, such that the coating is applied as a covering coating in the form of a frame 202 in a peripheral area of the element. Here, covering coating is understood to mean that within the range of the frame the degree of coverage by the coating is nearly 100%, i.e. that the coating 2 is applied over the entire surface within the limits of the frame. In a central area of the substrate 1 or of the glass or glass ceramic element 10, the coating is applied in the form of raster patterns 201 with different degrees of coverage. The degree of coverage calculated for the entire main surface of the glass or glass ceramic element 10 is preferably between at least 60% and at most 90%. The degree of coverage is preferably at least 65%, most preferably at least 70%. The degree of coverage is calculated as the ratio of the summed up areas 102 covered with the coating 2 to the entire main surface of the glass or glass ceramic element 10 or, correspondingly, of the glass or glass ceramic substrate 1. In other words, the degree of coverage generally results as the ratio of the coated surface area of a main surface to the total surface area of the considered main surface. The coated surface area is the surface area of the covered area 102 or, in the case of a plurality of such areas 102, the total of the surface areas of these areas 102.

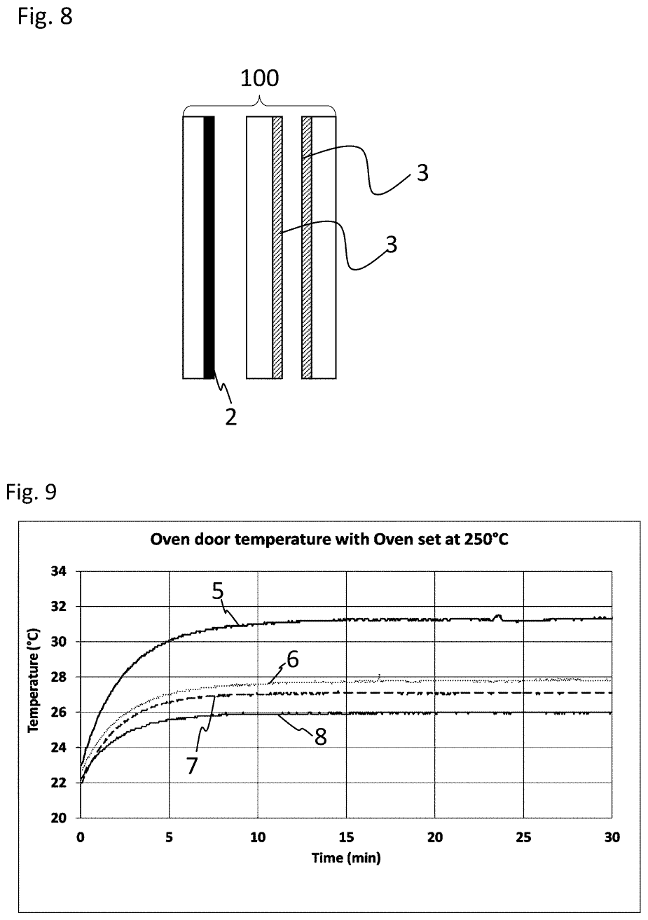

FIG. 6 schematically illustrates one variant of a first measurement setup for determining the outside temperature of the oven door. In this case, a conventional household oven 4 with a volume of 28.317 l or 5.3 ft³ is heated to 246° C. (maximum operating temperature in baking mode) or 468° C. (maximum operating temperature in pyrolysis mode), respectively. In this measurement setup, the oven door comprises three panes, and the two inner glass panes each have a coating 3. Here, the coatings 3 are disposed on the two inner glass panes on the main surfaces facing each other. The coatings 3 are in particular implemented as TCO-comprising layers or TCO layers and may also be referred to as low-e layers. In the examined exemplary embodiments, the outer glass pane has a coating 2 comprising an IR-reflecting pigment and a filler comprising or made of a material that has a specific molar heat capacity of not more than 5 mJ/(mol·K) and preferably a thermal conductivity of not more than 12 W/(m·K), and the coating 2 is applied on the side of the glass pane facing the interior of the oven. Here, the respective surface temperatures of the panes were determined using an IR camera 40 from Fluke, and a respective IR thermal image was captured at intervals of one minute. The distance between the thermal imaging camera and the outer pane of the oven door was 203.2 cm, here. In the test setup, the oven volume was 28.317 l, or 5.3 ft³. Such a pane assembly 100 of the oven door can be seen in FIG. 8.

FIG. 7 schematically shows a further measurement setup for determining the surface temperatures of a coated glass sheet under laboratory conditions. In this case, a laboratory oven 41 is heated to a temperature of 250° C. or 450° C., respectively. The oven has an opening with a diameter of 3 cm. The glass sheet 1 with the coating 2 to be measured is placed at a distance of 0.5 cm from this opening, with the coating 2 facing the opening of the oven. The surface temperature of the coated glass sheet 1 is determined using a pyrometer 42 (impac, IE 120/82L). The pyrometer 42 is arranged behind the decorated glass substrate 1 to be measured and at a distance of 50 cm from the glass sheet 1 to be measured.

Furthermore, FIG. 8 schematically shows the structure of the oven door, i.e. the pane assembly 100 for an oven door. Here, the non-coated side of the substrate 1 is arranged on the left in the figure and faces the outside (i.e. left in the figure). The intermediate sheet or pane and the inner pane of the oven door or of the pane assembly are each coated on one side with a coating 3. Here, coating 3 comprises transparent conductive oxides or is implemented as a TCO layer. The intermediate pane and the inner (here right) pane are arranged so that the coatings 3 face one another.

Finally, FIG. 9 shows a graph with the surface temperature of an oven door or of a coated glass or glass ceramic substrate plotted as a function of time for a measurement setup according to FIG. 7, for different coatings used. Curve 5 corresponds to the temperature profile as obtained for a glass-based coating comprising a black pigment (pigment Black 28, here). The maximum measured temperatures were also measured with the setup of FIG. 6.

Curves 6, 7, and 8 show the temperature profiles as obtained for glass-based coatings according to embodiments of the present disclosure, which in addition to a black pigment also comprise a filler in each case.

For example, in addition to a black pigment (pigment Brown 29), the coating according to curve 6 also comprises the filler PC1 according to TABLE 2 of the present specification (ZrO₂), specifically with a content of 2.5 vol % based on the solids content of the coating. It can be clearly seen that when this filler is used, the outside temperature at the oven door is significantly lower even after a period of 30 minutes (less than 28° C., curve 6) than that which is achieved with a coating that does not contain any filler (approx. 31° C., curve 5). Thus, the filler PC1 already allows to achieve a reduction in the outside temperature by 3° C. or even more here. Moreover, as can be seen from the graph of FIG. 9, this is not a short-term effect, rather the surface temperatures reach a plateau after a time of about 10 minutes, that is to say they remain more or less constant.

This temperature difference which is achieved with the filler PC1 can be further enhanced if another filler is used, for example a filler with even more favorable thermal properties, for example the filler PC2 (Nd₂O₃.2ZrO₂, curve 7), or the filler PC3 comprising 33.33 mol % of Nd₂O₃, 44.44 mol % of ZrO₂, and 22.22 mol % of Fe₂O₃, curve 8. With PC2, the surface temperature is reduced to approx. 27° C., i.e. a decrease by about 4° C. compared to an embodiment of a glass-based coating without filler, with PC3 even further to below 26° C., i.e. a decrease by 5° C. For the coatings corresponding to curves 7 and 8, the pigment Brown 29 was again used as the black pigment, in addition to the specified filler with 2.5 vol % in each case, based on the solids content of the coating.

However, it should be noted here, that the temperature difference considered here between the plateau temperatures or maximum temperatures (T_{Max}) which are reached after about 10 to 15 minutes on the outer surface of the oven door or of a coated glass or glass ceramic substrate, is not completely unambiguous per se, since the temperatures were different at the beginning of the measurement (T₀) in each case, as can also be seen from the graph in FIG. 9. This starting temperature T₀ essentially corresponds to the room temperature at the beginning of the measurements and thus can vary.

Therefore, the technical effect shall now be explained in further detail by way of the data in TABLE 6 below. TABLE 6 lists the maximum temperature T_{Max} for each case, and here T_{Max} was determined 30 minutes after the start of measurement. T₀ is the temperature at the start of measurement. ΔT indicates the difference between the maximum temperature T_{Max} and T₀, T_{Max}−T₀. Furthermore, the constituents of the coating are given, and for the pigments and, if applicable, the fillers, the percentage contents are also given. The percentages relate to the solids content of the coating or of the paste in each case and are based on the volume (vol % of solids content).

TABLE 6

| | | Oven temperature | | | |
|---|---|---|---|---|---|
| | | 250 ° C. | | 450 ° C. | |
| | | T_{Max} | ΔT | T_{Max} | ΔT |
| Sample | Constituents of the coating | [° C.] | [° C.] | [° C.] | [° C.] |
| 1 | Zn-based frit | 31.3 | 8.3 | 43.6 | 19.7 |
| | 30% Black 28 | | | | |
| 2 | Bi-based frit | 29.1 | 5.4 | 39.4 | 16.3 |
| | 17.5% Brown 29 | | | | |
| 3 | Bi-based frit | 31.8 | 5.3 | | |
| | 12.5% Brown 29; | | | | |
| | 5% PC2 (nano) | | | | |
| 4 | Bi-based frit | 29.9 | 3.3 | | |
| | 12.5% Brown 29; | | | | |
| | 5% PC2 (nano) | | | | |
| 5 | Bi-based frit | 29.9 | 2.8 | | |
| | 7.5% Brown 29; | | | | |
| | 10% PC2 (nano) | | | | |
| 6 | Bi-based frit | 29.2 | 2.6 | | |
| | 15% Brown 29; | | | | |
| | 2.5% PC2 | | | | |
| 7 | Bi-based frit | 30.2 | 1.4 | | |
| | 15% Brown 29; | | | | |
| | 2.5% PC3 | | | | |
| 8 | Bi-based frit | 28 | 6.6 | | |
| | 15% Brown 29; | | | | |
| | 2.5% PC4 | | | | |
| 9 | Bi-based frit | 28 | 6.3 | | |
| | 20% Brown 29; | | | | |
| | 2.5% PC2 | | | | |
| 10 | Bi-based frit | 27.1 | 5.1 | 44.5 | 20.4 |
| | 17.5% Brown 29; | | | | |
| | 5% PC2 | | | | |
| 11 | Bi-based frit | 27.8 | 5.1 | 44.7 | 17.9 |
| | 17.5% Brown 29; | | | | |
| | 2.5% PC1 | | | | |
| 12 | Zn-based frit | 26 | 3.9 | 48.4 | 25.4 |
| | 17.5% Brown 29; | | | | |
| | 2.5% PC2 | | | | |
| 13 | Zn-based frit | 27.8 | 5.6 | | |
| | 20% Brown 29; | | | | |
| | 2.5% PC2 | | | | |
| 14 | Zn-based frit | 27 | 4.5 | | |
| | 17.5% Brown 29; | | | | |
| | 5% PC2 | | | | |
| 15 | Bi-based frit | 29.6 | 6.1 | | |
| | 20% Brown 29; | | | | |
| | 2.5% PC2 | | | | |
| 16 | Bi-based frit | 30.4 | 6.7 | | |
| | 15% Brown 29, | | | | |
| | 2.5% PC3 | | | | |
| 17 | Bi-based frit | 29.8 | 6.6 | | |
| | 20% Brown 29; | | | | |
| | 2.5% PC3 | | | | |
| 18 | Zn-based frit | 29.6 | 6.1 | | |
| | 40% TiO₂; | | | | |
| | 2.5% PC3 | | | | |
| 19 | Zn-based frit | 27.7 | 4.2 | 51.4 | 27.5 |
| | 40% TiO₂; | | | | |
| | 2.5% PC2 | | | | |
| 20 | Zn-based frit | 29.2 | 6.1 | | |
| | 30% Black 28; | | | | |
| | 2.5% PC3 | | | | |
| 21 | Zn-based frit | 29.3 | 6 | 49.4 | 24.1 |
| | 30% Black 28; | | | | |
| | 2.5% PC2 | | | | |
| 22 | Bi-based frit | 31.4 | 7.3 | | |
| | 17.5% Brown 29; | | | | |
| | 2.5% PC2 | | | | |

Here, sample 1 corresponds to a coating composition for which the temperature profile according to curve 5 of FIG. 9 was obtained.

It can be seen, here, that with coatings according to embodiments, T_{Max} remains below the maximum temperatures T_{Max} which are achieved for or with conventional coatings (for example compare sample 2 with sample 6), or that with very different starting temperatures T₀ at least a significantly lower temperature difference ΔT is achievable (for example compare sample 2 with sample 7).

### LIST OF REFERENCE SYMBOLS

1 Glass or glass ceramic substrate
10 Glass or glass ceramic element
11, 12 Surfaces, main surfaces
100 Pane assembly
101 Area of a main surface without coating
102 Area of a main surface with coating
2 Coating
201 Raster pattern
202 Frame
21 Binder
22 Pigment particles
23 Filler particles
3 Further coating
4 Oven
40 Thermal camera
41 Laboratory oven
42 Pyrometer
5, 6, 7, 8 Temperature profile on the surface of an oven door as a function of time for different coatings
d Thickness of the glass or glass ceramic substrate
l Length of the substrate/element
b Width of the substrate/element

What is claimed is:

1. A glass or glass ceramic element for household and/or heating appliances, comprising:
a transparent glass or glass ceramic substrate that has a main surface; and
a coating disposed on at least a portion of the main surface,
wherein the coating is a glass-based coating that comprises a pigment and a filler, wherein the pigment comprises an IR-reflecting material, and wherein the filler has a specific molar heat capacity of not more than 5 mJ/(mol·K).

2. The element of claim 1, wherein the filler has a thermal conductivity of not more than 12 W/(m·K).

3. The element of claim 1, wherein the filler comprises a material selected from a group consisting of zirconium oxide, hafnium oxide, a chalcogenide, a rare-earth element oxide, ZrO₂, and any combinations thereof.

4. The element of claim 1, wherein the filler comprises a chalcogenide according to a formula: A_{2+X}B_{Y}D_{Z}E₇,
wherein A is at least one element from a group of rare-earth elements and is present as a trivalent cation,
wherein B is at least one element which is present as a tetravalent cation,
wherein D is at least one element which is present as a pentavalent cation,
wherein E is at least one element which is present as a divalent anion, and wherein:
0≤X≤1.1;
0≤Y≤3;
0≤Z≤1.6; and
8≤3X+4Y+5Z≤15.

5. The element of claim 1, wherein the pigment is selected from a group consisting of: an absorption pigment, pigment particles with a size distribution with a d₅₀ value of the equivalent diameter in a range between 0.15 μm and 2 μm, pigment particles with a size distribution with a d₅₀ value of the equivalent diameter in a range 0.5 μm to 1.8 μm, and any combinations, and/or
wherein the filler is selected from a group consisting of: filler particles with a size distribution with a d₅₀ value of the equivalent diameter in a range between 0.15 μm and 25 μm, filler particles with a size distribution with a d₅₀ value of the equivalent diameter in a range between 0.2 μm to 25 μm, filler particles with a size distribution with a d₅₀ value of the equivalent diameter in a range between 0.5 μm to 5 μm, and any combinations thereof.

6. The element of claim 1, wherein the coating has a solids content with a fraction of the pigment of at least 7 vol % and at most 43 vol %, and/or
wherein the coating comprises a binder, and wherein the coating has a solids content with a fraction of the binder of at least 50 vol % and at most 85 vol %.

7. The element of claim 1, wherein the pigment comprises a material selected from a group consisting of: an inorganic material, a high temperature stable inorganic material, a high temperature stable inorganic oxidic material, a chromium-containing pigment, a chromium-containing iron oxide, a chromium-containing hematite, a chromium-containing spinel, and any combinations thereof.

8. The element of claim 1, wherein the substrate has a feature selected from a group consisting of: a soda-lime glass substrate, a borosilicate glass substrate, a planar substrate sheet shape, a curved substrate sheet shape, an arched substrate sheet shape, a thickness between at least 1 mm and at most 10 mm, and a thickness between at least 2 mm and at most 8 mm.

9. The element of claim 1, wherein the coating has a feature selected from a group consisting of: the pigment being an absorption pigment, a thickness between at least 2 μm and 20 μm, a thickness between at least 3 μm and 15 μm, and a ratio of the pigment to the filler based on volume of at least 0.75:1 and at most 12.5:1.

10. The element of claim 1, wherein the portion comprises at least 60% and not more than 95% of the main surface.

11. The element of claim 1, wherein the main surface comprises a second portion that does not comprise the coating.

12. The element of claim 1, wherein the coating comprises a content of a conductive oxide that is smaller than 500 ppm based on the weight, and wherein the conductive oxide is selected from a group consisting of indium tin oxide, fluorine tin oxide, aluminum zinc oxide, antimony tin oxide, and any combinations thereof.

13. The element of claim 1, wherein the element is sized and configured as an oven door window pane or a fireplace window pane.

14. A paste, comprising:
a binder precursor phase, the binder precursor phase comprising a material selected from a group consisting of: a glassy material, a glass flux, a glass frit forming material;
a pigment comprising an IR-reflecting material; and
a filler having a specific molar heat capacity of not more than 5 mJ/(mol·K).

15. The paste of claim 14, wherein the filler has a thermal conductivity of not more than 12 W/(m·K).

16. The paste of claim 14, wherein the filler comprises a material selected from a group consisting of zirconium oxide, hafnium oxide, a chalcogenide, a rare-earth element oxide, ZrO₂, and any combinations thereof.

17. The paste of claim 14, wherein the filler comprises a chalcogenide according to a formula: A_{2+X}B_{Y}D_{Z}E₇,
wherein A is at least one element from a group of rare-earth elements and is present as a trivalent cation,
wherein B is at least one element which is present as a tetravalent cation,
wherein D is at least one element which is present as a pentavalent cation,
wherein E is at least one element which is present as a divalent anion, and wherein:
0≤X≤1.1;
0≤Y≤3;
0≤Z≤1.6; and
8≤3X+4Y+5Z≤15.

18. The paste of claim 14, wherein the pigment is selected from a group consisting of: an absorption pigment, pigment particles with a size distribution with a d₅₀ value of the equivalent diameter in a range between 0.15 μm and 2 μm, pigment particles with a size distribution with a d₅₀ value of the equivalent diameter in a range 0.5 μm to 1.8 μm, and any combinations, and/or
wherein the filler is selected from a group consisting of: filler particles with a size distribution with a d₅₀ value of the equivalent diameter in a range between 0.15 μm and 25 μm, filler particles with a size distribution with a d₅₀ value of the equivalent diameter in a range between 0.2 μm to 25 μm, filler particles with a size distribution with a d₅₀ value of the equivalent diameter in a range between 0.5 μm to 5 μm, and any combinations thereof.

19. The paste of claim 14, wherein the coating has a solids content with a fraction of the pigment of at least 7 vol % and at most 43 vol %, and/or
wherein the coating comprises a binder, and wherein the coating has a solids content with a fraction of the binder of at least 50 vol % and at most 85 vol %.

20. The paste of claim 14, wherein the pigment comprises a material selected from a group consisting of: an inorganic material, a high temperature stable inorganic material, a high temperature stable inorganic oxidic material, a chromium-containing pigment, a chromium-containing iron oxide, a chromium-containing hematite, a chromium-containing spinel, and any combinations thereof.

21. A method for producing a glass or glass ceramic element for household and/or heating appliances, comprising:
providing a transparent glass or glass ceramic substrate that has a deformation temperature;
providing a paste having a binder precursor phase, a pigment, a filler, and a screen printing medium, the binder precursor phase comprising a material selected from a group consisting of: a glassy material, a glass flux, a glass frit forming material, the pigment comprising an IR-reflecting material, and the filler having a specific molar heat capacity of not more than 5 mJ/(mol·K), wherein the paste has a softening point below the deformation temperature;
screen printing the paste onto on at least a portion of a main surface of the substrate to obtain a wet layer coating on the substrate; and
firing the substrate having the wet layer thereon at a temperature above the softening point and below the deformation temperature to form the coating.
